(19) United States
(12) Patent Application Publication
(10) Pub. No.: US 2026/0066928 A1
(43) Pub. Date: Mar. 5, 2026

(54) REDUCED COMPLEXITY FREQUENCY SELECTIVE LINEARIZATION

(71) Applicant: Telefonaktiebolaget LM Ericsson (publ), Stockholm (SE)

(72) Inventors: Mohamed Hamid, Malmö (SE); Farshid Ghasemzadeh, Sollentuna (SE); Magnus Nilsson, Lund (SE)

(21) Appl. No.: 19/108,254

(22) PCT Filed: Sep. 2, 2022
(86) PCT No.: PCT/EP2022/074499

§ 371 Date: Mar. 3, 2025

(51) Int. Cl. H04B 1/04

(52) U.S. Cl. CPC H04B 1/04; H04B 2001/0425

(57) ABSTRACT

In various embodiments of the present disclosure, provided is a system to perform reduced complexity frequency selective linearization. In an embodiment, multistage digital predistortion (DPD) can linearize different parts of the spectrum differently. The first stage captures the signal across the entire linearization bandwidth where the least stringent linearization requirement and general unwanted emission requirements are targeted. Second stage pre-distorts a down-sampled signal where second least stringent requirements across the linearization bandwidth are aimed for. This “peel-off” process continues until the final stage which pre-distorts the portion of the spectrum with the most stringent linearization requirements. Consequently, earlier stages run at higher rates to linearize wider spectrum while later stages run at lower rates to selectively further linearize portions of spectrum that have already passed through earlier stages.

### TECHNICAL FIELD

The present application relates generally to digital predistortion of a signal before power amplification to increase linearization and reduce signal spillover.

### BACKGROUND

Power amplifiers (PAs) are inherently nonlinear, where the output signal does not match the input signal. The nonlinearity can vary depending on the power output of the PA, with higher nonlinearities at higher power levels. PAs are generally also more efficient at higher power levels, therefore, for a PA to operate efficiently, the PA will likely have a higher nonlinearity. The PAs should therefore be linearized to meet linearity requirements and to avoid ruining error vector magnitude (EVM), decreasing out-of-band emission (OoBE), and decreasing an adjacent channel leakage ratio (ACLR). Typically, linearization of the PA is done using digital predistortion (DPD) which can compensate for both amplitude-to-amplitude distortion (AM-AM) and amplitude to phase distortion (AM-PM).

There are several applications where PAs are used where there are stringent linearization requirements to reduce OoBE in one or more frequency bands. For example, in the case of Sub-Band Full Duplex (SBFD) where non-overlapping sub-bands or Physical Resource Blocks (PRBs) are assigned for Downlink (DL) and Uplink (UL) simultaneously within a Time Division Duplex (TDD) DL time slot for the sake of enhancing UL coverage and latency, DL leakage into the UL band should be kept way below ordinary DL ACLR requirements to ensure that the receiver noise floor and thus receiver sensitivity directly impacting coverage is not degraded. In the case of Millimeter Wave (mmW), operation in bands adjacent to Earth Exploration Satellite Service (EESS) bands have an OoBE requirement that is much more stringent than mmW ACLR requirements and general unwanted emissions. Therefore, the ACLR and unwanted emission levels at one side of a band (concerned EESS band) should be at a very low level compared to the other side of the band.

Conventional DPDs that perform frequency neutral linearization are designed to fulfill the most stringent linearization requirement across the entire operational frequency. These types of DPDs can be overly complex or provide insufficient performance and therefore violate the one or more power consumption and area constraints for an integrated circuit. Additionally, very sharp filters can be used to complement DPDs, but designing such filters can be difficult.

In Per Landin, “Digital Baseband Modeling and Correction of Radio Frequency Power Amplifiers” PhD thesis, KTH Royal Institute of Technology, 2012, use of a frequency weighting function is introduced to minimize a more relevant cost function than the frequency neutral cost function. As an example, to suppress the out-of-band distortion more than the in-band distortion. This solution still requires running the whole DPD at a rate that covers the entire frequency range to be linearized. Moreover, it involves a convolution operation which comes with an added computational complexity.

In A. K. Kwan, M. F. Younes, O. Hammi, M. Helaoui, N. Boulejfen and F. M. Ghannouchi, “Selective Intermodulation Compensation in a Multi-Stage Digital Predistorter for Nonlinear Multi-Band Power Amplifiers,” in IEEE Journal on Emerging and Selected Topics in Circuits and Systems, vol. 7, no. 4, pp. 534-546, December 2017, a technique is introduced that reduces the rate for DPD feedback path in a multiband scenario based on two stage DPD. The first stage is static DPD where narrow band signals are used to extract static nonlinear terms of the DPD. Consequently, a second stage DPD is used to count for memory effects and other dynamics for multiband PAs. Even though the rate of the DPD feedback path is reduced, the rate of the DPD forward path still covers the entire linearized frequency range, thus increasing the computational complexity.

### SUMMARY

Systems and methods are disclosed for a reduced complexity frequency selective linearization. In one embodiment, a method performed by a digital predistortion system for a wireless transmission node comprising receiving a digital input signal for a transmission, the digital input signal having a sampling rate that is based on a linearization bandwidth of the digital input signal. The method also includes performing, at the sampling rate of the digital input signal, a first stage digital predistortion on the digital input signal to thereby provide a first pre-distorted digital signal. The method can also include, for a particular sub-band of two or more sub-bands of the first pre-distorted digital signal, down-sampling either the first pre-distorted digital signal or a frequency-shifted version of the first pre-distorted signal at a reduced sampling rate to provide a down-sampled digital signal, wherein the reduced sampling rate is based on a bandwidth of the particular sub-band and is lower than the sampling rate of the digital input signal and performing, at the reduced sampling rate, a second stage digital predistortion on the down-sampled digital signal to thereby provide a second pre-distorted signal. The method can also include further processing the first pre-distorted signal and the second pre-distorted signal to provide a pre-distorted output signal for transmission by the wireless transmission node.

In an embodiment, down-sampling either the first pre-distorted digital signal or a frequency-shifted version of the first pre-distorted signal comprises down-sampling the first pre-distorted digital signal.

In an embodiment, a method can include frequency shifting the particular sub-band of the first pre-distorted digital signal to provide the frequency-shifted version of the down-sampled digital signal in which the particular sub-band of the first pre-distorted digital signal is centered at zero frequency, wherein down-sampling either the first pre-distorted digital signal or a frequency-shifted version of the first pre-distorted signal comprises down-sampling the frequency-shifted version of the first pre-distorted signal.

In an embodiment, a method can include frequency shifting and down-sampling sub-bands of the two or more sub-bands other than the particular sub-band to provide one or more additional down-sampled sub-band signals. In the embodiment, the performing the second stage digital predistortion comprises performing the second stage digital predistortion based on both the down-sampled digital signal and the one or more down-sampled sub-band signals to provide the second pre-distorted signal.

In an embodiment, the down-sampling the two or more sub-bands further comprises down-sampling the two or more sub-bands by a single down-sampler in response to the two or more sub-bands having equivalent bandwidths.

In an embodiment the down-sampling the two or more sub-bands further comprises down-sampling the two or more sub-bands by respective down-samplers in response to the two or more sub-bands having different bandwidths.

In an embodiment, a method can include up-sampling the second pre-distorted signal to provide an up-sampled second pre-distorted signal. The method can also include applying a predetermined delay to the first pre-distorted signal to provide a delayed first pre-distorted signal.

In an embodiment, a method can include combining the up-sampled second pre-distorted signal and the delayed first pre-distorted signal and subtracting the first pre-distorted digital signal of the particular sub-band at one of the second state DPD or at combiner 326 to provide a pre-distorted signal.

In an embodiment, a method can include down-sampling sub-bands other than the particular sub-band of the first pre-distorted signal. In an embodiment, the method can include up-sampling the sub-bands other than the particular sub-band of the first pre-distorted signal to provide up-sampled signals of the sub-bands other than the particular sub-band of the first pre-distorted signal.

In an embodiment, a method can include up-sampling the second pre-distorted signal to provide an up-sampled second pre-distorted signal. The method can also include combining the up-sampled second pre-distorted signal and the up-sampled signals of the first pre-distorted signal to provide a pre-distorted signal.

In an embodiment, a method can include converting the second pre-distorted signal to an analog signal. The method can also include combining the analog signal and other analog signals corresponding to other sub-bands of the two or more sub-bands to provide the pre-distorted output signal.

In an embodiment, a transmitting node configured to implement a digital predistortion system, the transmitting node comprising a radio interface and processing circuitry configured to receive a digital input signal for a transmission, the digital input signal having a sampling rate that is based on a linearization bandwidth of the digital input signal. The transmitting node can also perform, at the sampling rate of the digital input signal, a first stage digital predistortion on the digital input signal to thereby provide a first pre-distorted digital signal. The transmitting node can also for a particular sub-band of two or more sub-bands of the first pre-distorted digital signal, down-sample the particular sub-band of the first pre-distorted digital signal at a reduced sampling rate to provide a down-sampled digital signal, wherein the reduced sampling rate is based on a bandwidth of the particular sub-band and is lower than the sampling rate of the digital input signal and perform, at the reduced sampling rate, a second stage digital predistortion on the down-sampled digital signal to thereby provide a second pre-distorted signal. The transmitting node can also further process the first pre-distorted digital signal and the second pre-distorted digital signal to provide a pre-distorted output signal for transmission by the transmitting node.

In an embodiment, the down-sampling either the first pre-distorted digital signal or a frequency-shifted version of the first pre-distorted signal comprises down-sampling the first pre-distorted digital signal.

In an embodiment, a transmitting node can frequency shift the particular sub-band of the first pre-distorted digital signal to provide the frequency shifted down-sampled digital signal in which the particular sub-band of the first pre-distorted digital signal is centered at zero frequency and down-sampling either the first pre-distorted digital signal or a frequency-shifted version of the first pre-distorted signal comprises down-sampling the frequency-shifted version of the first pre-distorted signal.

In an embodiment, a transmitting node can frequency shift and down-sample sub-bands of the two or more sub-bands other than the particular sub-bands to provide one or more additional down-sampled sub-band signals; and subtract the first pre-distorted digital signal of the particular sub-band and perform the second stage digital predistortion based on both the down-sampled signal and the one or more down-sampled sub-band signals to provide the second pre-distorted signal.

In an embodiment, a transmitting node can up-sample the second pre-distorted signal to provide an up-sampled second pre-distorted signal and apply a predetermined delay to the first pre-distorted signal to provide a delayed first pre-distorted signal.

In an embodiment, a transmitting node can combine the up-sampled second pre-distorted signal and the delayed first pre-distorted signal to provide a pre-distorted signal.

In an embodiment, a transmitting node can down-sample sub-bands other than the particular sub-band of the first pre-distorted signal. The transmitting node can also up-sample the sub-bands other than the particular sub-band of the first pre-distorted signal to provide up-sampled signals of the first pre-distorted signal.

In an embodiment, a transmitting node can up-sample the second pre-distorted signal to provide an up-sampled second pre-distorted signal and combine the up-sampled second pre-distorted signal and the up-sampled signals of the first pre-distorted signal to provide the pre-distorted signal.

In an embodiment, a transmitting node can convert the second pre-distorted signal to an analog signal at a reduced digital to analog conversion rate and combine the analog signal and other analog signals corresponding to other sub-bands of the two or more sub-bands to provide the pre-distorted output signal.

In an embodiment, a transmitting node is at least one of a User Equipment (UE) device or a base station.

In an embodiment, a non-transitory computer-readable storage medium that includes executable instructions to cause a processor device of a transmission node to receive a digital input signal for a transmission, the digital input signal having a sampling rate that is based on a linearization bandwidth of the digital input signal. The processor device can also perform, at the sampling rate of the digital input signal, a first stage digital predistortion on the digital input signal to thereby provide a first pre-distorted digital signal. The processor device can also, for a particular sub-band of two or more sub-bands of the first pre-distorted digital signal, down-sample either the particular sub-band of first pre-distorted digital signal or a frequency-shifted version of the sub-band of the first pre-distorted signal at a reduced sampling rate to provide a down-sampled digital signal, wherein the reduced sampling rate is based on a bandwidth of the particular sub-band and is lower than the sampling rate of the digital input signal, and perform, at the reduced sampling rate, a second stage digital predistortion on the down-sampled digital signal to thereby provide a second pre-distorted signal. The processor device can also further process the first pre-distorted digital signal and the second pre-distorted signal to provide a pre-distorted digital output signal for transmission by the transmission node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIG. 2 is a flowchart illustrating a method implemented in a communication system to perform frequency selective linearization in accordance with one embodiment of the present disclosure;

FIG. 3 is a schematic block diagram of multistage digital predistortion architecture that performs frequency selective linearization in accordance with one embodiment of the present disclosure;

FIG. 4 is a schematic block diagram of multistage digital predistortion architecture that performs frequency selective linearization in accordance with one embodiment of the present disclosure;

FIG. 5 is a schematic block diagram of multistage digital predistortion architecture that performs frequency selective linearization in accordance with one embodiment of the present disclosure;

FIG. 6 is a schematic block diagram of multistage digital predistortion architecture that performs frequency selective linearization in accordance with one embodiment of the present disclosure;

FIG. 7 is a schematic block diagram of a radio access node according to some embodiments of the present disclosure;

FIG. 8 is a schematic block diagram of the radio access node of FIG. 7 according to some other embodiments of the present disclosure;

FIG. 9 is a schematic block diagram of a User Equipment device (UE) according to some embodiments of the present disclosure;

FIG. 10 is a schematic block diagram of the UE of FIG. 9 according to some other embodiments of the present disclosure;

FIG. 11 is a flowchart illustrating a method implemented in a communication system to perform frequency selective linearization in accordance with one embodiment of the present disclosure;

FIG. 12 is a flowchart illustrating a method implemented in a communication system to perform frequency selective linearization in accordance with one embodiment of the present disclosure;

FIG. 13 is a flowchart illustrating a method implemented in a communication system to perform frequency selective linearization in accordance with one embodiment of the present disclosure;

FIG. 14 is a flowchart illustrating a method implemented in a communication system to perform frequency selective linearization in accordance with one embodiment of the present disclosure;

FIG. 15 is a spectrum graph depicting a result of frequency selective linearization in accordance with one embodiment of the subject disclosure; and

FIG. 16 is a spectrum graph depicting a result of frequency selective linearization in accordance with one embodiment of the subject disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

In various embodiments of the present disclosure, a system is provided to perform reduced complexity frequency selective linearization. In an embodiment, multistage digital predistortion (DPD) linearizes different parts of the spectrum differently. A first stage DPD captures the signal across the entire linearization bandwidth where the least stringent linearization requirement and general unwanted emission requirements are targeted. A second stage DPD pre-distorts a down-sampled signal and performs DPD for a portion of the spectrum to satisfy second least stringent requirements across a reduced linearization bandwidth. This “peel-off” process continues until a final stage DPD is performed which pre-distorts a portion of the spectrum with the most stringent linearization requirements. Consequently, earlier stages run at higher sampling rates to linearize wider spectrum while later stages run at lower rates to selectively further linearize portions of spectrum that have already passed through earlier stages. Moreover, the earlier the DPD stage, the less complex the model structure it uses and vice versa.

In an embodiment, the nonlinear distortions in different portions of the spectrum can be suppressed differently to meet different linearization requirements related to Out of Band Emissions (OoBE) and Adjacent Channel Leakage Ratio (ACLR) requirements across different frequency parts. The idea is to adopt a multistage DPD where the sampling rate, or DPD rate, and complexity of each stage are traded. This method can be used for different use cases such as Sub-Band Full Duplex (SBFD) or mitigation of the unwanted emission towards Earth Exploration Satellite Service (EESS) bands, but the method is not limited to these example use cases.

In various embodiments, some of the advantages of the present disclosure include one or more of the following: (1) different parts of frequency spectrum can be linearized differently depending on different linearization requirements; (2) the first stage DPD runs at a moderately high sampling rate (e.g., a conventional sampling rate for DPD) but it is a simple DPD as the most lenient linearization requirements across the spectrum drive the DPD model structure; (3) the second and beyond DPD stages run at lower rates depending on the bandwidth to be linearized at each stage with more complex DPD structures depending on the respective linearization requirements adopted at each stage; and (4) usage of multistage DPD implies using ‘nested’ nonlinearities which enables characterizing richer nonlinear functions for later stages

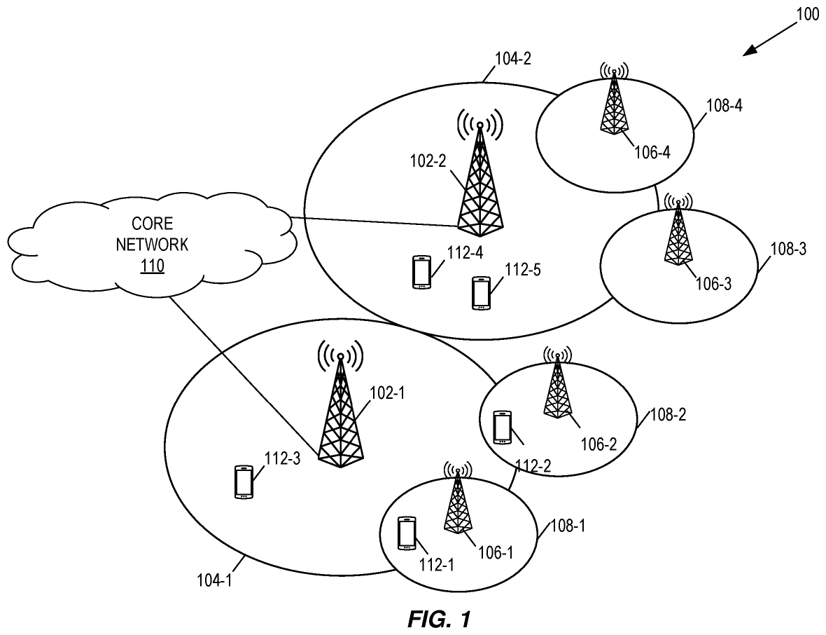

FIG. 1 illustrates one example of a cellular communications system 100 in which embodiments of the present disclosure may be implemented. In the embodiments described herein, the cellular communications system 100 could be a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 102-1 and 102-2, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

In an embodiment, the reduced complexity frequency selective linearization disclosed herein can be performed at any of the base stations 102, lower power nodes 106, or wireless communication devices 112.

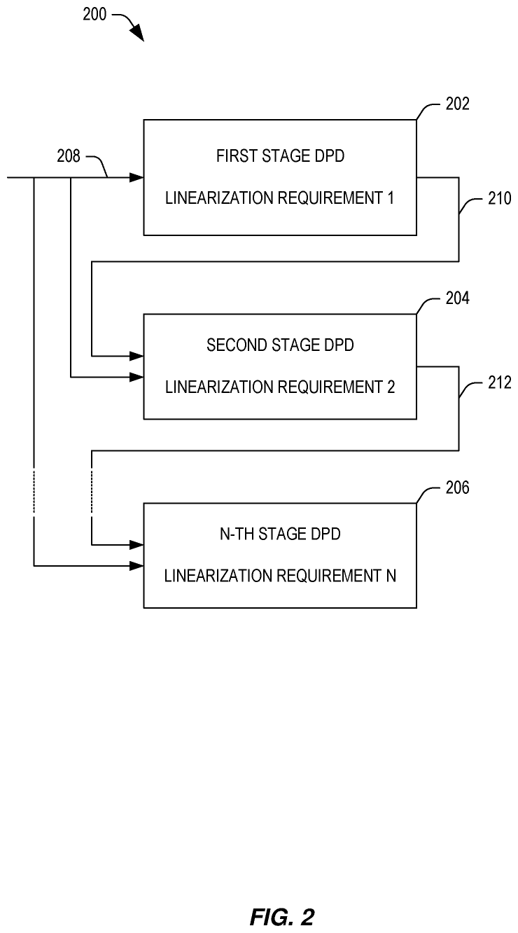

FIG. 2 illustrates is a multi-stage DPD system 200 that performs frequency selective linearization in accordance with one embodiment of the present disclosure. The multi-stage DPD system 200 is preferably implemented in a wireless transmission node such as, e.g., a base station 102, a lower power node 106, or a wireless communication device 112.

As illustrated in the example embodiment of FIG. 2, the multi-stage DPD system 200 includes multiple DPD stages which, in the illustrated example embodiment, include a first DPD stage 202, a second DPD stage 204, and a third DPD stage 206 that perform a multi-stage DPD on a digital input signal 208 over a (full) linearization band for the digital input signal 208. The DPD stages may be implemented in hardware, such as, e.g., one or more Application Specific Integrated Circuits (ASICs). Different linearization requirements are required for different portions (also referred to herein as “sub-bands”) of the linearization band. At the first stage DPD 202, the sampling rate of the digital input signal 208 is a first sampling rate that is based on the bandwidth of the full linearization band, and the first stage DPD 202 performs a DPD on the digital input signal 208 at the first sampling rate over the full linearization band of the digital input signal 208 in accordance with the least stringent linearization requirement that needs to be met across any portion of the linearization band. The first stage DPD 202 outputs a resulting output signal 210 at the first sampling rate. The second stage DPD 204 performs a second DPD on each of one or more sub-bands of the output signal 210 from the first stage DPD 202 in accordance with a more stringent linearization requirement(s) for the one or more sub-bands. More specifically, as described below in detail, for each sub-band to be processed by the second stage DPD 204, the second stage DPD 204 optionally applies a frequency shift to the output signal 210 such that the sub-band to be processed by the second stage DPD 204 is centered at zero frequency (e.g., if not already at zero frequency), down-samples the frequency-shifted output signal 210 to a second sampling rate that is based on a bandwidth of the sub-band being processed, and then performs a DPD on the down-sampled signal for the sub-band in accordance with the more stringent linearization requirements of the sub-band. The output of the second stage DPD is output signal 212. The third stage DPD 206 performs a third DPD on a sub-band(s) of the output signal 212 from the second stage DPD 204 in accordance with the most stringent linearization requirement at a sampling rate that is based on the bandwidth of the sub-band(s) processed by the third stage DPD 206. Note that while three DPD stages are illustrated in the example of FIG. 2, there may be any number of two or more DPD stages.

In an embodiment, the digital input signal 208 includes three sub-bands with a requirement of a reduced leakage from the sub-bands on the edges into the middle sub-band compared to ordinary ACLR requirements. It should be noted that this setup which represents SBFD architecture is an illustrative example which is generalizable to other cases where a specific portion of the linearized frequency spectrum imposes different requirements than the remaining spectrum.

If the spectrum is divided into K sub-bands, where each sub-band is indexed as k and occupied by a baseband time domain signal xₖ(n), then the signal occupies the entire spectrum, and x(n) is given by:

$$x ( n ) = {\sum }_{k = 1}^{K} {x}_{k} ( n ) exp ( j 2 π {f}_{S B k} n ) \qquad ( 1 )$$

With f_{SBk} being the baseband frequency of sub-band k. The signal x(n) can then be passed through the first DPD 202, f_{DPD1}, to generate u_{stg1}(n) that can facilitate linearizing the output of the power amplifier (PA) in a way that the least stringent linearization requirement across the entire linearization bandwidth is achieved. u_{stg1}(n) can be expressed as:

$${u}_{stg 1} ( n ) = {f}_{D P D 1} ( x ( n ) ) \qquad ( 2 )$$

Thereafter, to facilitate linearizing a particular sub-band of the K sub-bands, u_{stg1}(n) is downsampled to K sub-band components as:

$${u}_{S B k} ( n ) = resample ( {u}_{stg 1} ( n ) exp ( - \frac{j 2 π {f}_{S B k}}{{f}_{{u}_{stg 1}}} n ) , \frac{B {W}_{S B k}}{B {W}_{{u}_{stg 1}}} ) \qquad ( 3 )$$

where BW_{SBk} is the bandwidth of the sub-band k and BWᵤ_{_{stg1}} is the bandwidth of the signal u_{stg1}(n) which is equivalent to the entire linearization bandwidth. It is to be appreciated that Eqn 3 shows that each sub-band k is additionally frequency shifted such that the down-sampled digital signal corresponding to sub-band k is centered at zero frequency.

After the frequency shift, the frequency shifted down-sampled digital signal is passed through a second stage DPD 204, f_{DPD2}, that linearizes (a) targeted sub-band(s) which require(s) further non-linear distortion suppression. It should be noted that f_{DPD2} is a multi-variate non-linear function where all sub-bands' outputs from the first stage DPD are involved to generate a second-stage pre-distorted signal for the targeted sub-band(s).

$${u}_{stg 2} ( n ) = {f}_{D P D 2} ( {u}_{S B k} ( n ) ) , ∀ k = 1. . K \qquad ( 4 )$$

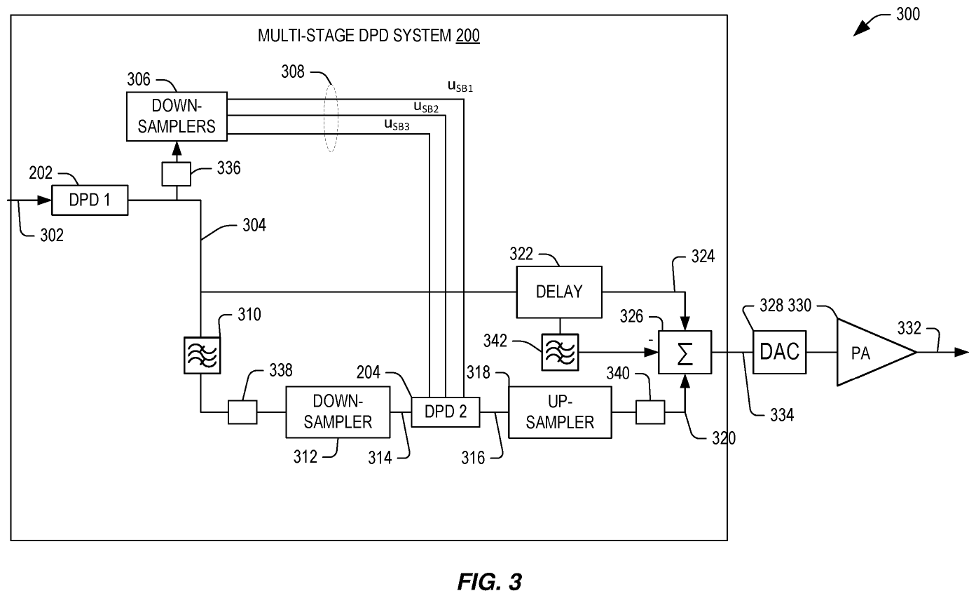

After passing the second stage DPD, pre-distorted signals in all sub-bands are passed through RF chains. Example RF chains are described in more detail in relation to the example embodiments of the multi-state DPD system shown in FIGS. 3-6.

Turning now to FIG. 3, illustrated is a schematic block diagram of multistage digital predistortion architecture 300 that shows an exemplary multi-stage DPD system 200 that performs frequency selective linearization in accordance with one embodiment of the present disclosure.

In the embodiment shown in FIG. 3, the first stage DPD 202 performs DPD on the digital input signal 302. In an embodiment, the digital input signal 302 can have a sampling rate that corresponds to a bandwidth of the digital input signal 302. The first stage DPD 202 can perform the DPD at the sampling rate of the digital input 302 and output a first pre-distorted digital signal 304 that has been linearized based on a first linearization requirement.

A filter 310 can isolate a particular sub-band of the first pre-distorted digital signal 304, a frequency shifter 338 can then frequency shift the particular sub-band of the first pre-distorted digital signal 304 to be centered at zero frequency, and subsequently a down-sampler 312 can down-sample the frequency shifted sub-band of the first pre-distorted signal 304 to a reduced sampling rate to provide a down-sampled digital signal 314. The reduced sampling rate of the down-sampled digital signal 314 can be based on the bandwidth of the particular sub-band and it can be lower than the sampling rate of the digital input signal 302. The second stage DPD 204 can then perform the second stage DPD on the down-sampled digital signal 314 based on a second linearization requirement that is more stringent than the first linearization requirement. The down-sampled digital signal 314 can also be frequency shifted before the downsampling as described above, and the second stage DPD 204 can then perform the second stage DPD on the frequency shifted down-sampled digital signal 314. The second stage DPD 204 can generate a second pre-distorted signal 316 that can be up-sampled back to the original sample rate of the digital input signal 302 and frequency shifted by frequency shifter 340 to reverse the first frequency shift by frequency shifter 338, resulting in an up-sampled second pre-distorted signal 320.

A bank of down-samplers 306, can down-sample the first pre-distorted digital signal (304) to provide one or more down-sampled sub-band signals 308 of the two or more down-sampled sub-band associated with the digital input signal 302 for the sub-bands other than the particular sub-band. A frequency shifter 336 can be provided before the down sampler 307 to frequency shift the first pre-distorted digital signal 304 before being down-sampled by the down-samplers 306. It is to be appreciated that while FIG. 3 depicts just a single down-sampler 306, this is for ease of depiction, and that in some embodiments, a respective down-sampler can be provided for each sub-band of the first pre-distorted digital signal 304. The second stage DPD 204 can additionally perform the second stage DPD of the down-sampled digital signal 314 based on the two or more down-sampled sub-band signals 308.

A delay 322 can also be applied to the first pre-distorted digital signal 304 to create a delayed first pre-distorted signal 324 before summing at combiner 326 the first pre-distorted digital signal 304 and the up-sampled second pre-distorted signal 320. A frequency filter 342 can also remove the particular sub-band corresponding to the second pre-distorted signal 320 from the delayed first pre-distorted signal 324, and that can be combined with the signals 324 and 320 at combiner 326. The delay can account for any delays caused in the processing chain of the up-sampled second pre-distorted signal 320 and ensure that the delayed first pre-distorted signal 324 and the up-sampled second pre-distorted signal 320 are in phase with each other. After summing at combiner 326, the combined signal (a pre-distorted signal 334) can be sent to a Digital to Analog (DAC) converter and a PA 330 to provide the pre-distorted output signal 332 for transmission by one of the wireless nodes.

It is to be appreciated that while FIGS. 3-6 depict first and second stage DPD, in other embodiments, additional stages are possible, depending on the number of linearization requirements associated with the various sub-bands of the transmission.

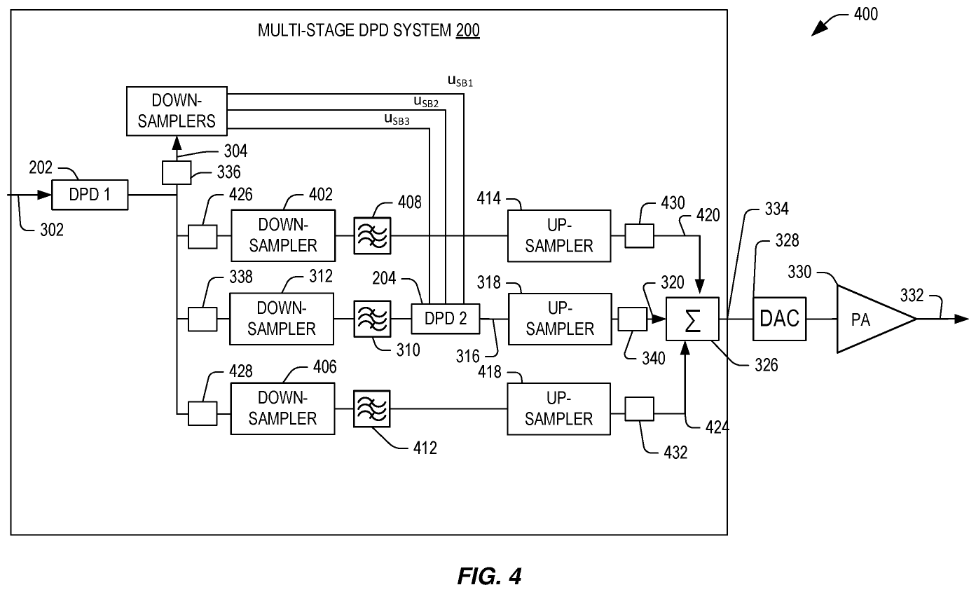

Turning now to FIG. 4, illustrated is a schematic block diagram of multistage digital predistortion architecture 400 that shows an exemplary multi-stage DPD system 200 that performs frequency selective linearization in accordance with one embodiment of the present disclosure.

In the embodiment shown in FIG. 4, the first pre-distorted digital signal 304 can be frequency shifted by frequency shifters 426, 338, and 428 and then down-sampled by down-samplers 402, 312, and 406, or one for each sub-band of the first pre-distorted digital signal 304. In embodiments where there are N-sub-bands, there can be N down-samplers. After the first pre-distorted digital signal 304 is down-sampled, producing 3 identical down-sampled first pre-distorted digital signals, filters 408, 310, and 412 can filter the signals such that the output is a signal corresponding to each respective sub-band. The second stage DPD 204 can perform the second stage DPD on the particular sub-band to produce a second pre-distorted signal 316, which can be up-sampled along with the other signals by up-samplers 414, 318, and 418. Since the signals of each sub-band have been down-sampled and up-sampled, just as the signal of the particular signal that underwent the second stage DPD, there is no need to delay any of the signals 320, 420, or 424, and so they can be frequency shifted by frequency shifters 430, 340, and 432, and then summed up at combiner 326 to create a pre-distorted signal 334, and further processed to result in the pre-distorted output signal 332. It is to be appreciated that each of the down-samplers 306, 312, 402 and 406, and the up-samplers 414, 318, and 418 can include anti-aliasing filters.

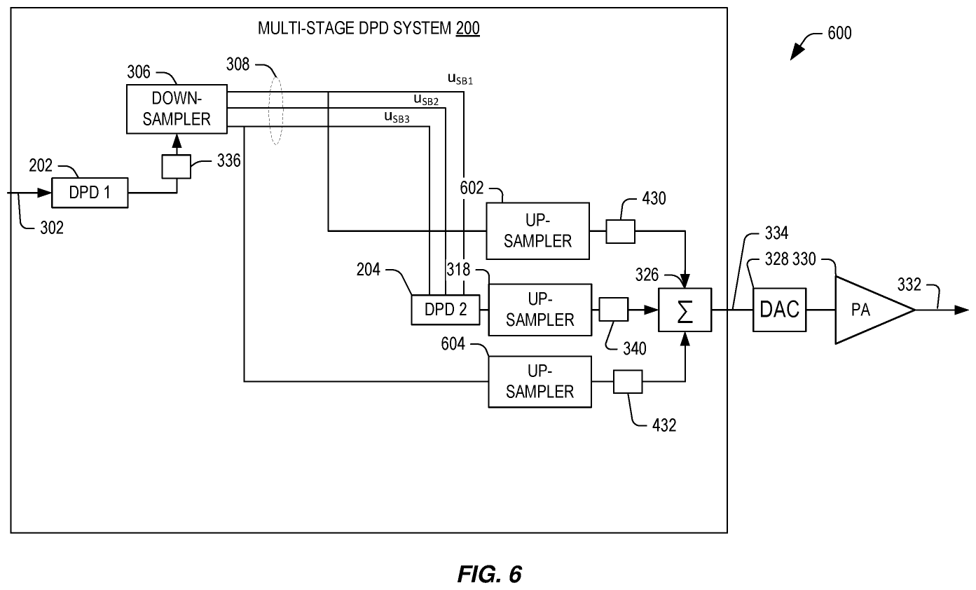

It is to be appreciated that in FIG. 4, the DAC 328 can run at a rate equivalent to the entire linearization bandwidth that is used to excite the PA 330. Also, in this embodiment, the bandwidths of linearized sub-bands can be different so there are multiple down-samplers 402, 312, and 406 that can down-sample at respective rates depending on the bandwidth of the sub-bands, so that all the inputs to the second stage DPD 204 have a similar rate. In other embodiments, such as in FIG. 6, if each of the linearized sub-bands have the same rate, a single down-sampler 306 is used to generate the two or more down-sampled sub-band signals 308 and up-samplers 602, 318, and 604 can up-sample the two or more down-sampled sub-band signals 308 as well as the second pre-distorted signal 316 before summing at combiner 326, digital to analog conversion at DAC 328 and power-amplification at PA 330.

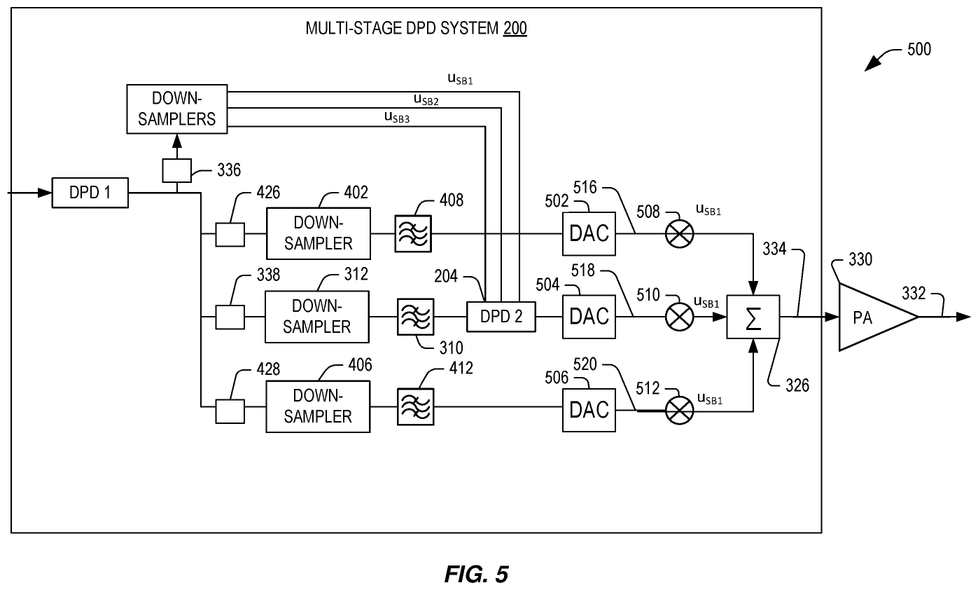

Turning now to FIG. 5, illustrated is a schematic block diagram of multistage digital predistortion architecture 500 that shows an exemplary multi-stage DPD system 200 that performs frequency selective linearization in accordance with one embodiment of the present disclosure. In the embodiment shown in FIG. 5, a two-stage digital predistortion architecture is shown where multiple single reduced-rate DACs 502, 504, and 506 and mixers 508, 510, and 512 are utilized.

FIG. 5 depicts a similar architecture as in FIG. 4, except that the down-sampled signals corresponding to the two or more sub-bands and the second pre-distorted digital signal output from the second stage DPD 204 are converted to analog signals at DACs 502, 504, and 506. Since the signals are at a lower frequency since the first pre-distorted digital signal 304 was down-sampled by down-samplers 402, 312, and 406, the RF mixers 508, 510, and 512 can modulate the analog signals 516, 518, and 520 with the baseband frequencies of each of the respective sub-bands before the signals are summed at combiner 326 to create a pre-distorted signal 334 and then amplified by PA 330 to provide the pre-distorted output signal 332 for transmission.

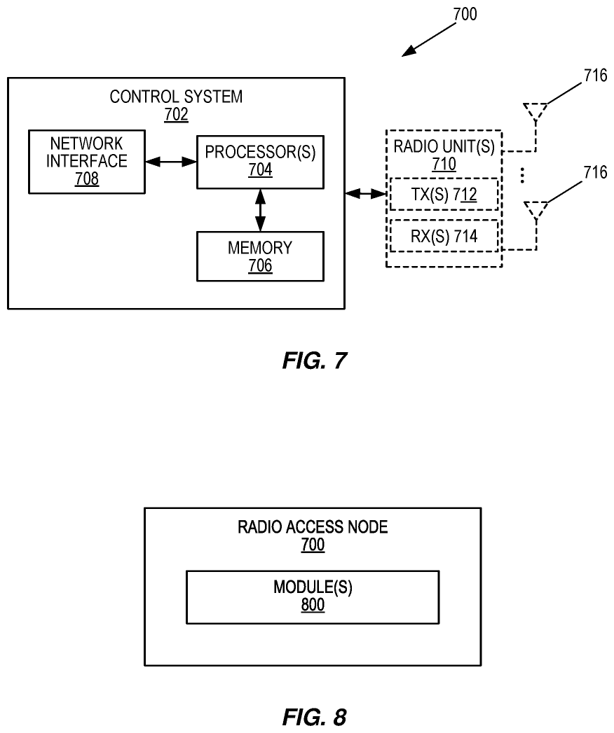

FIG. 7 is a schematic block diagram of a radio access node 700 according to some embodiments of the present disclosure. Optional features are represented by dashed boxes. The radio access node 700 may be, for example, a base station 102 or 106 or a network node that implements all or part of the functionality of the digital predistortion system 200 described herein. As illustrated, the radio access node 700 includes a control system 702 that includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. In addition, the radio access node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of a radio access node 700 as described herein. In some embodiments, the function(s) are implemented in software that is stored, e.g., in the memory 706 and executed by the one or more processors 704.

FIG. 8 is a schematic block diagram of the radio access node 700 according to some other embodiments of the present disclosure. The radio access node 700 includes one or more modules 800, each of which is implemented in software. The module(s) 800 provide the functionality of the radio access node 700 described herein.

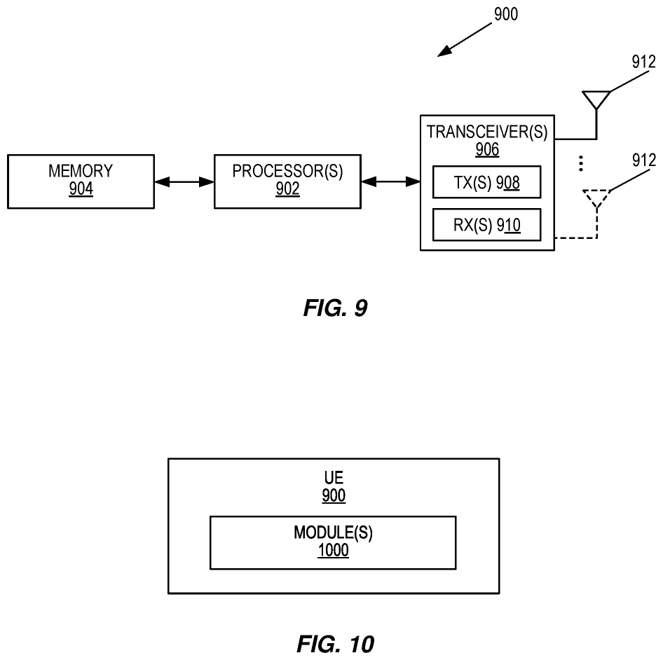

FIG. 9 is a schematic block diagram of a wireless communication device 900 according to some embodiments of the present disclosure. As illustrated, the wireless communication device 900 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the digital predistortion system 200 described above may be fully or partially implemented in software that is, e.g., stored in the memory 904 and executed by the processor(s) 902. Note that the wireless communication device 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the wireless communication device 900 and/or allowing output of information from the wireless communication device 900), a power supply (e.g., a battery and associated power circuitry), etc.

In some embodiments, a computer program including instructions which, when executed by at least one processor, causes the at least one processor to carry out the functionality of the digital predistortion system 200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the wireless communication device 900 according to some other embodiments of the present disclosure. The wireless communication device 900 includes one or more modules 1000, each of which is implemented in software. The module(s) 1000 provide the functionality of the wireless communication device 900 described herein.

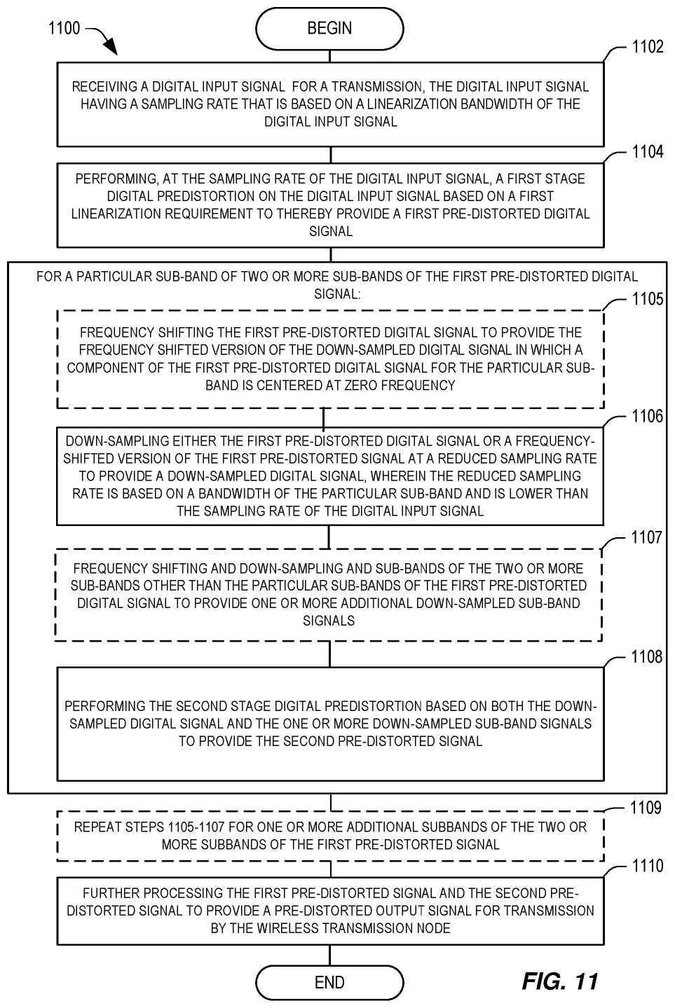

FIG. 11 is a flowchart illustrating a method 1100 performed by the digital predistortion system 200 for a wireless transmission node (e.g., a base station 102 or a wireless communication device 112) to perform frequency selective linearization in accordance with one embodiment of the present disclosure. Optional steps are represented by dashed lines/boxes.

The method 1100 begins at 1102 where the digital predistortion system 200 receives a digital input signal 302 for a transmission, the digital input signal 302 having a sampling rate that is based on a linearization bandwidth of the digital input signal.

At 1104, the digital predistortion system 200 performs, at the sampling rate of the digital input signal 302, a first stage digital predistortion (e.g., by DPD 202) on the digital input signal 302 based on a first linearization requirement to thereby provide a first pre-distorted digital signal 304 that has been linearized based on the first linearization requirement.

At 1105, which is an optional step, for a particular sub-band of two or more sub-bands of the first pre-distorted digital signal, the digital predistortion system 200 frequency shifts the first pre-distorted digital signal 304 to provide the frequency shifted version of the down-sampled digital signal that was down-sampled by down-sampler 312 in which a component of the first pre-distorted digital signal for the particular sub-band is centered at zero frequency. In some cases, the particular sub-band may already be centered at zero frequency.

At 1106, the digital predistortion system 200 down-samples (e.g., by down sampler 312) either the first pre-distorted digital signal 304 or a frequency-shifted version of the first pre-distorted signal (from step 1105) at a reduced sampling rate to provide a down-sampled digital signal 314, wherein the reduced sampling rate is based on a bandwidth of the particular sub-band and is lower than the sampling rate of the digital input signal 302. The reduced sampling rate of the down-sampled digital signal 314 can be based on the bandwidth of the particular sub-band and it can be lower than the sampling rate of the digital input signal 302.

At 1107, which is also an optional step, the digital predistortion system 200 frequency shifts (by frequency and down-samples (e.g., by down samplers 306, 402, or 406)) and sub-bands of the two or more sub-bands other than the particular sub-bands of the first pre-distorted digital signal to provide one or more additional down-sampled sub-band signals.

At 1108, the digital predistortion system 200 performs, at the reduced sampling rate, a second stage digital predistortion (e.g., by DPD 204) on either the down-sampled digital signal or a frequency-shifted version of the down-sampled digital signal, based on a second linearization requirement that is more stringent than the first linearization requirement to thereby provide a second pre-distorted signal. The second linearization requirement can be stricter in the case there is a protected band nearby.

At 1109, 1105-1107 are repeated for one or more additional sub-bands of the two or more sub-bands of the first pre-distorted signal. This can be repeated N times (e.g., N-th Stage DPD 206), where at each stage, progressively more precise predistortions can be applied to fewer or smaller sub-bands. This is done when in the case of there being more than two different linearization requirements for the two or more sub-bands.

At 1110, the digital predistortion system 200further processes the first pre-distorted signal and the second pre-distorted signal to provide a pre-distorted output signal for transmission by the wireless transmission node. In an embodiment the further processing includes adding the second stage pre-distorted digital signal back to the first stage pre-distorted digital signal and converting the digital signals to an analog signal by DAC 328 and amplifying the signals for transmission by PA 330. In an embodiment, the further processing can also include performing additional rounds of predistortion (e.g., by Nth stage DPD 206) in the case of their being more than two linearization requirements.

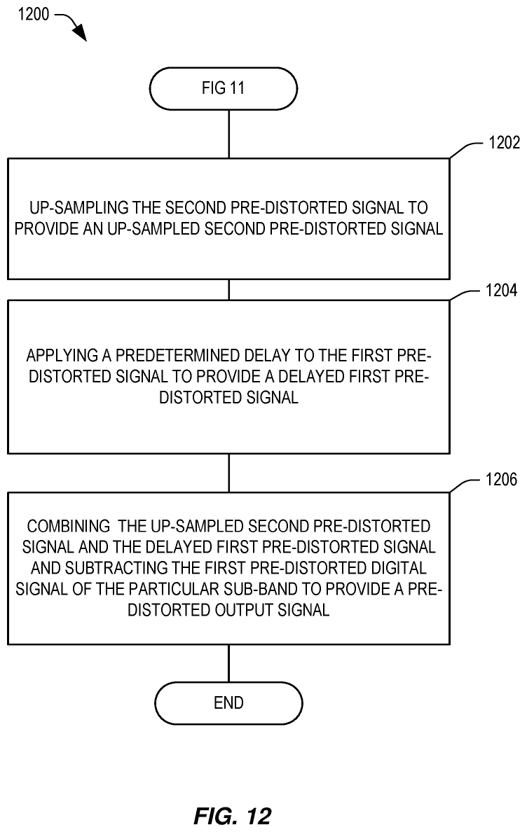

FIG. 12 is a flowchart illustrating a method 1200 performed by the digital predistortion system 200 for a wireless transmission node (e.g., a base station 102 or a wireless communication device 112) to perform frequency selective linearization in accordance with one embodiment of the present disclosure.

The method 1200 provides additional steps to be used with method 1100 and in some embodiments, method 1200 can comprise the “further processing” of step 1110.

At 1202, the digital predistortion system 200 up-samples the second pre-distorted signal to provide an up-sampled second pre-distorted signal. In addition to the upsampling, the second pre-distorted signal can also be frequency shifted to move the particular sub-band associated with the second pre-distorted signal back to the original location with the overall bandwidth of the input signal. This frequency shift thus reverses the frequency shift that occurs at 1106.

At 1204, the digital predistortion system 200 applies a predetermined delay to the first pre-distorted signal to provide a delayed first pre-distorted signal. The delay can account for any delays caused in the processing chain of the up-sampled second pre-distorted signal 320 and ensure that the delayed first pre-distorted signal 324 and the up-sampled second pre-distorted signal 320 are in phase with each other. At 1206, the digital predistortion system 200 combines the up-sampled second pre-distorted signal and the delayed first pre-distorted signal and subtracting the first pre-distorted digital signal of the particular sub-band to provide a pre-distorted output signal (334). In an embodiment, the subtraction the first pre-distorted digital signal of the particular sub-band can either take place at the second stage DPD 204, or at 326.

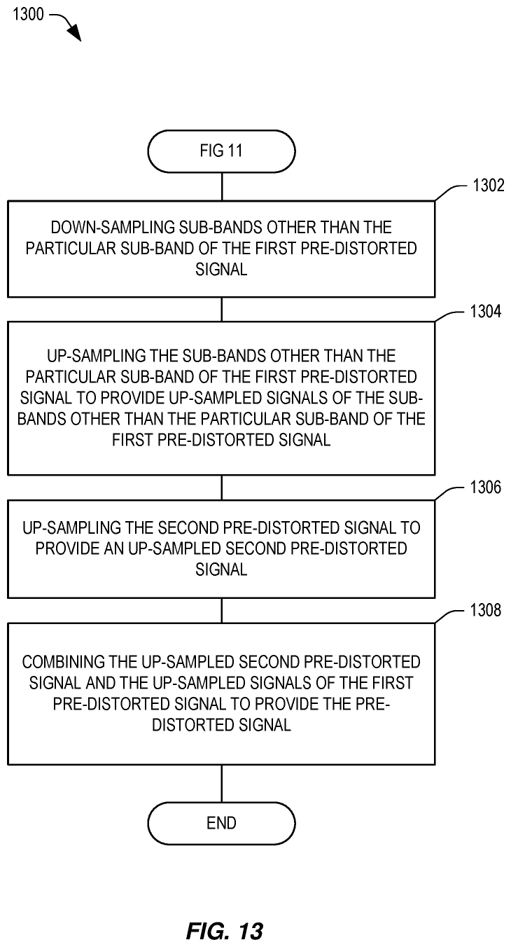

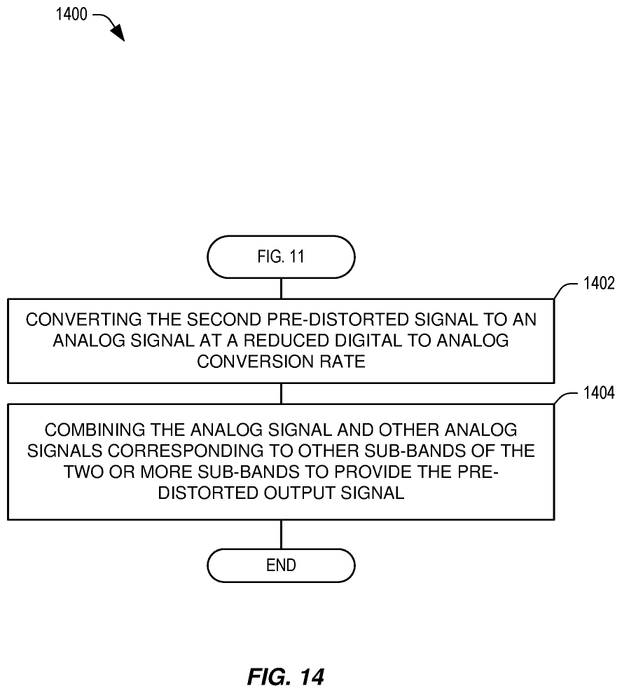

FIG. 13 is a flowchart illustrating a method 1300 performed by the digital predistortion system 200 for a wireless transmission node (e.g., a base station 102 or a wireless communication device 112) to perform frequency selective linearization in accordance with one embodiment of the present disclosure.

The method 1300 provides additional steps after method 1100 and in some embodiments, method 1300 can comprise the “further processing” of step 1110.

At 1302, the digital predistortion system 200 down-samples sub-bands (e.g., by down samplers 306, 402, or 406) other than the particular sub-band of the first pre-distorted signal.

At 1304, the digital predistortion system 200 up-samples (e.g., by up-samplers 602 and 604) the sub-bands other than the particular sub-band of the first pre-distorted signal to provide up-sampled signals of the sub-bands other than the particular sub-band of the first pre-distorted signal.

At 1306, the digital predistortion system 200 up-samples (e.g., by up-sampler 318) the second pre-distorted signal to provide an up-sampled second pre-distorted signal.

At 1308, the digital predistortion system 200 combines (at 326) the up-sampled second pre-distorted signal and the up-sampled signals of the first pre-distorted signal to provide the pre-distorted signal.

The method 1400 provides additional steps after method 1100 and in some embodiments, method 1400 comprises the “further processing” of step 1110.

At 1402, the digital predistortion system 200 converts (e.g., by DAC 504) the second pre-distorted signal to an analog signal 330 at a reduced digital to analog conversion rate.

At 1404, the digital predistortion system 200 combines the analog signal and other analog signals corresponding to other sub-bands of the two or more sub-bands (that were converted to analog signals by DACs 502 and 506) to provide the pre-distorted output signal.

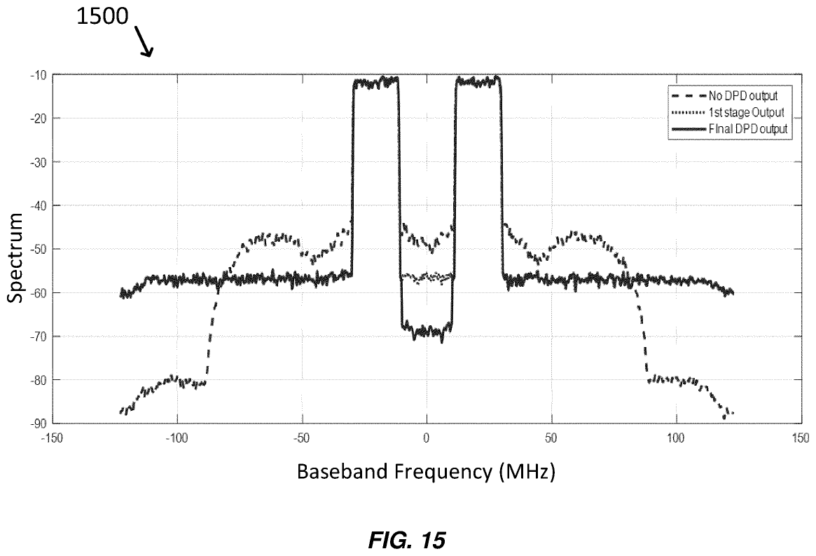

Turning now to FIG. 15, illustrated is a spectrum graph 1500 depicting a result of frequency selective linearization in accordance with one embodiment of the subject disclosure. The spectrum graph 1500 depicts results of a testing setup depicting the spectrum of the signals without DPD, after 1^{st} stage DPD and final DPD output for SBFD setup when using proposed frequency selective DPD.

In the testing setup associated with spectrum graph 1500, the SBFD transmitter has a 20 MHz UL sub-band that is neighbored by two 20 MHz DL sub-bands on both sides. Therefore, the leakage from both DL sub-bands into UL sub-bands is suppressed further beyond what an ordinary DPD achieves. Accordingly, the UL sub-band is passed through a second DPD stage. As FIG. 15 shows, a second stage DPD provides ˜13 dB ACLR improvement within the UL sub-band compared to ˜-47 dBc ACLR achieved by the first stage DPD. The DPD parameters used for both stages along with performance achieved are shown in Table 1:

| | | | | DL→UL | DL →DL |
|---|---|---|---|---|---|
| | f_{DPD} | DPD rate | | ACLR | ACLR |
| 1^{st} stage | GMP (7, 5, 3) * | 245.76 | Ms/s | −47.3 dBc | −47.1 dBc |
| DPD | | | | | |
| 2^{nd} stage | GMP (11, 0, 0) * | 20 | Ms/s | −59.7 dBc | — |
| DPD | | | | | |

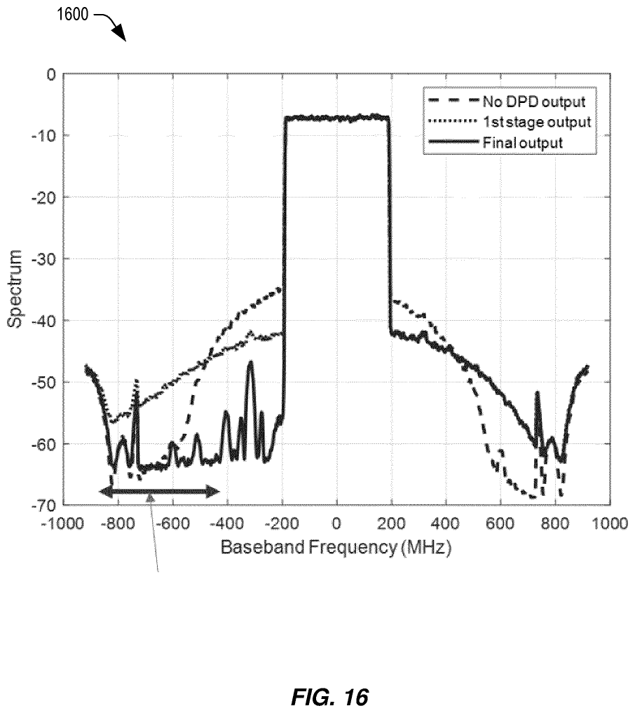

Turning now to FIG. 16, illustrated is a spectrum graph 1600 depicting a result of frequency selective linearization in accordance with one embodiment of the subject disclosure. The spectrum graph 1600 depicts results of a testing setup depicting the spectrum of the signals without DPD, after 1^{st} stage DPD and final DPD output for a millimeter wave (mmW) Tx when using proposed frequency selective DPD. The EESS band is the Adjacent frequency band to the left.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DCI Downlink Control Information
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
PDSCH Physical Downlink Shared Channel
P-GW Packet Data Network Gateway
PRS Positioning Reference Signal
QoS Quality of Service
RAM Random Access Memory
RAN Radio Access Network
ROM Read Only Memory
RP Reception Point
RRH Remote Radio Head
RTT Round Trip Time
SCEF Service Capability Exposure Function
SMF Session Management Function
TCI Transmission Configuration Indicator
TP Transmission Point
TRP Transmission/Reception Point
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a digital predistortion system for a wireless transmission node, comprising:
receiving a digital input signal for a transmission, the digital input signal having a sampling rate that is based on a linearization bandwidth of the digital input signal;
performing, at the sampling rate of the digital input signal, a first stage digital predistortion on the digital input signal to thereby provide a first pre-distorted digital signal; and
for a particular sub-band of two or more sub-bands of the first pre-distorted digital signal:
down-sampling either the particular sub-band of the first pre-distorted digital signal or a frequency-shifted version of the particular sub-band of the first pre-distorted digital signal at a reduced sampling rate to provide a down-sampled digital signal, wherein the reduced sampling rate is based on a bandwidth of the particular sub-band and is lower than the sampling rate of the digital input signal;
performing, at the reduced sampling rate, a second stage digital predistortion on the down-sampled digital signal to thereby provide a second pre-distorted digital signal; and
further processing the first pre-distorted digital signal and the second pre-distorted signal to provide a pre-distorted output signal for transmission by the wireless transmission node.

2. The method of claim 1, wherein down-sampling either the particular sub-band of the first pre-distorted digital signal or a frequency-shifted version of the particular sub-band of the first pre-distorted signal comprises down-sampling the particular sub-band of the first pre-distorted digital signal.

3. The method of claim 1, further comprising:
frequency shifting the particular sub-band of the first pre-distorted digital signal to provide the frequency shifted version of the down-sampled digital signal in which the particular sub-band of the first pre-distorted digital signal is centered at zero frequency,
wherein down-sampling either the particular sub-band of the first pre-distorted digital signal or the frequency-shifted version of the particular sub-band of the first pre-distorted signal comprises down-sampling the frequency-shifted version of the particular sub-band of the first pre-distorted signal.

4. The method of claim 1, further comprising:
frequency shifting and down-sampling sub-bands of the two or more sub-bands other than the particular sub-band to provide one or more additional down-sampled sub-band signals; and
wherein performing the second stage digital predistortion comprises performing the second stage digital predistortion based on both the down-sampled digital signal and the one or more additional down-sampled sub-band signals to provide the second pre-distorted digital signal.

5. The method of claim 4, wherein the down-sampling the two or more sub-bands further comprises down-sampling the two or more sub-bands by respective down-samplers in response to the two or more sub-bands having different bandwidths.

6. The method of claim 4, wherein the down-sampling the two or more sub-bands further comprises down-sampling the two or more sub-bands by a single down-sampler in response to the two or more sub-bands having equivalent bandwidths.

7. The method of claim 1, wherein the further processing comprises:
up-sampling the second pre-distorted digital signal to provide an up-sampled second pre-distorted digital signal; and
applying a predetermined delay to the first pre-distorted digital signal to provide a delayed first pre-distorted digital signal.

8. The method of claim 7, wherein the further processing further comprises:
combining the up-sampled second pre-distorted digital signal and the delayed first pre-distorted digital signal and subtracting the first pre-distorted digital signal of the particular sub-band at one of a second stage DPD or at combiner 326 to provide a pre-distorted signal.

9. The method of claim 1, wherein the further processing further comprises:
down-sampling sub-bands other than the particular sub-band of the first pre-distorted signal; and
up-sampling the down-sampled sub-bands other than the particular sub-band of the first pre-distorted digital signal to provide up-sampled signals of the sub-bands other than the particular sub-band of the first pre-distorted digital signal.

10. The method of claim 9, wherein the further processing further comprises:
up-sampling the second pre-distorted digital signal to provide an up-sampled second pre-distorted signal; and
combining the up-sampled second pre-distorted signal and the up-sampled signals of the sub-bands other than the particular sub-band of the first pre-distorted digital signal to provide a pre-distorted digital signal.

11. The method of claim 1, further comprising:
converting the second pre-distorted digital signal to an analog signal; and
combining the analog signal and other analog signals corresponding to other sub-bands of the two or more sub-bands to provide the pre-distorted output signal.

12. A transmitting node configured to implement a digital predistortion system, the transmitting node comprising a radio interface and processing circuitry configured to:
receive a digital input signal for a transmission, the digital input signal having a sampling rate that is based on a linearization bandwidth of the digital input signal;
perform, at the sampling rate of the digital input signal, a first stage digital predistortion on the digital input signal to thereby provide a first pre-distorted digital signal; and
for a particular sub-band of two or more sub-bands of the first pre-distorted digital signal:
down-sample the particular sub-band of the first pre-distorted digital signal or a frequency-shifted version of the particular sub-band of the first pre-distorted digital signal at a reduced sampling rate to provide a down-sampled digital signal, wherein the reduced sampling rate is based on a bandwidth of the particular sub-band and is lower than the sampling rate of the digital input signal;
perform, at the reduced sampling rate, a second stage digital predistortion on the down-sampled digital signal to thereby provide a second pre-distorted signal; and
further process the first pre-distorted digital signal and the second pre-distorted digital signal to provide a pre-distorted output signal for transmission by the transmission node.

13. The transmitting node of claim 12, wherein down-sampling either the particular sub-band of the first pre-distorted digital signal or a frequency-shifted version of the particular sub-band of the first pre-distorted signal comprises down-sampling the particular sub-band of the first pre-distorted digital signal.

14. The transmitting node of claim 12 wherein the processing circuitry is further configured to:
frequency shift the particular sub-band of the first pre-distorted digital signal to provide the frequency shifted down-sampled digital signal in which the particular sub-band of the first pre-distorted digital signal is centered at zero frequency; and
down-sampling either the particular sub-band of the first pre-distorted digital signal or a frequency-shifted version of the particular sub-band of the first pre-distorted signal comprises down-sampling the frequency-shifted version of the particular sub-band of the first pre-distorted signal.

15. The transmitting node of claim 12 wherein the processing circuitry is further configured to:
frequency shift and down-sample sub-bands of the two or more sub-bands other than the particular sub-bands to provide one or more additional down-sampled sub-band signals;
subtracting the first pre-distorted digital signal of the particular sub-band;
perform the second stage digital predistortion based on both the down-sampled signal and the one or more additional down-sampled sub-band signals to provide the second pre-distorted digital signal.

16. The transmitting node of claim 12, wherein the processing circuitry is further configured to:
up-sample the second pre-distorted digital signal to provide an up-sampled second pre-distorted digital signal; and
apply a predetermined delay to the first pre-distorted digital signal to provide a delayed first pre-distorted digital signal.

17. The transmitting node of claim 16, wherein the processing circuitry is further configured to:
combine the up-sampled second pre-distorted digital signal and the delayed first pre-distorted digital signal to provide a pre-distorted digital signal.

18. The transmitting node of claim 12, wherein the processing circuitry is further configured to:
down-sample sub-bands other than the particular sub-band of the first pre-distorted signal; and
up-sample the down-sampled sub-bands other than the particular sub-band of the first pre-distorted digital signal to provide up-sampled signals of the first pre-distorted digital signal.

19. The transmitting node of claim 18, wherein the
processing circuitry is further configured to:
up-sample the second pre-distorted digital signal to provide an up-sampled second pre-distorted signal; and
combine the up-sampled second pre-distorted signal and the up-sampled signals of the sub-bands other than the particular sub-band of the first pre-distorted digital signal to provide the pre-distorted digital signal.

20. The transmitting node of claim 12, wherein the processing circuitry is further configured to:
convert the second pre-distorted digital signal to an analog signal at a reduced digital to analog conversion rate; and
combine the analog signal and other analog signals corresponding to other sub-bands of the two or more sub-bands to provide the pre-distorted output signal.

21. The transmitting node of claim 12, wherein the transmitting node is one of a User Equipment device or a base station.

22. A non-transitory computer-readable storage medium that includes executable instructions to cause a processor device of a transmission node to: receive a digital input signal for a transmission, the digital input signal having a sampling rate that is based on a linearization bandwidth of the digital input signal;
perform, at the sampling rate of the digital input signal, a first stage digital predistortion on the digital input signal to thereby provide a first pre-distorted digital signal; and
for a particular sub-band of two or more sub-bands of the first pre-distorted digital signal:
down-sample either the particular sub-band of the first pre-distorted digital signal or a frequency-shifted version of the particular sub-band of the first pre-distorted signal at a reduced sampling rate to provide a down-sampled digital signal, wherein the reduced sampling rate is based on a bandwidth of the particular sub-band and is lower than the sampling rate of the digital input signal;
perform, at the reduced sampling rate, a second stage digital predistortion on the down-sampled digital signal to thereby provide a second pre-distorted signal; and
further process the first pre-distorted digital signal and the second pre-distorted digital signal to provide a pre-distorted output signal for transmission by the transmission node.
